(19) United States
(12) Patent Application Publication
(10) Pub. No.: US 2024/0354738 A1
(43) Pub. Date: Oct. 24, 2024

(54) METHOD FOR CONTACTLESS INTERACTIONS WITH A PAYMENT TERMINAL, CORRESPONDING PAYMENT TERMINAL AND COMPUTER PROGRAM

(71) Applicant: BANKS AND ACQUIRERS INTERNATIONAL HOLDING, Suresnes (FR)

(72) Inventor: Laurent MEGE, Portes Les Valence (FR)

(73) Assignee: BANKS AND ACQUIRERS INTERNATIONAL HOLDING, Suresnes (FR)

(21) Appl. No.: 18/254,652

(22) PCT Filed: Nov. 29, 2021
(86) PCT No.: PCT/EP2021/083327

§ 371 Date: May 26, 2023

(30) Foreign Application Priority Data
Nov. 30, 2020 (FR) 2012376

(51) Int. Cl. G06Q 20/32

(52) U.S. Cl. CPC G06Q 20/3278

(57) ABSTRACT

A method for processing modulations of an electromagnetic field of a contactless payment terminal. Said contactless payment terminal emits an electromagnetic field to establish a near-field communication (NFC) with a user's payment device. In particular, the method includes the following steps, which are carried out inside the payment terminal: —detecting, by means of the payment terminal, at least one modulation of the emitted electromagnetic field, the at least one modulation resulting from at least one touch of the payment device on the payment terminal, —determining a modulation frequency N of the electromagnetic field emitted by the payment terminal, said frequency N being a number greater than or equal to 1 and corresponding to N touches of the payment device on the payment terminal, —selecting at least one function on the payment terminal according to the modulation frequency N of the determined electromagnetic field.

### 1. TECHNICAL FIELD OF THE INVENTION

The present invention relates to contactless interactions between a user and an electronic payment terminal (EPT). In particular, the invention relates to the selection by the user of at least one function on a contactless type payment terminal, with the user's payment device.

By contactless payment terminal, it should be understood an electronic payment terminal using near field communication (NFC) technology to establish a communication with a payment device of the user and thus make an electronic transaction for the purchase of a product or a service.

### 2. PRIOR ART

Currently, it is possible to purchase a product or a service in a dematerialized manner by simple contact, or close proximity, of the customer's payment device (such as for example his bank card or his mobile phone) with a so-called contactless electronic payment terminal, located at a merchant's place of business. This type of contactless payment uses near field communication (NFC) technology. This short-range high-frequency wireless communication technology allows the exchange of information between peripherals up to a distance of about 10 cm.

Generally, the contactless EPT initiates the communication by emitting an electromagnetic field, then by sending a command to the customer's payment device, which is also equipped to communicate via NFC. The payment device then responds by retro-modulation of the incident wave, which allows the payment device and the EPT to exchange transaction information by amplitude modulation of the electromagnetic field.

To make this contactless transaction via NFC communication, the customer's payment device is equipped with a chip coupled to an antenna. The chip contains the information the EPT needs to accept the transaction. The merchant's EPT is then able to access the data stored on the customer's payment device, record a transaction, and communicate with a remote authentication server.

This mode of payment thus allows the customer to no longer need to directly manipulate the EPT to make his purchase, such as for example when he enters his confidential code on the keypad of the EPT. The end of the payment transaction is, in most cases, materialized by printing by the EPT a payment receipt for the customer and the merchant.

However, in order to limit the production of waste, and to protect the health of consumers, in particular against the harmfulness of the chemical compounds that make up the ink or the paper of the payment receipt, it is recommended to no longer systematically print this receipt at the end of the transaction. That's why, at present, before proceeding to print the payment receipt, some merchants ask their customers to find out if they wish to have this payment receipt. Thus, in the coming years, the payment receipt may no longer be printed by default, unless specifically requested by the customer.

Consequently, the choice of whether or not to print the payment receipt requires a manipulation of the EPT by the merchant, who then selects a print function via the keypad of the EPT. However, in view of the current health crisis, contactless interaction between users and payment terminals is becoming more and more important. Thus, even if the interaction with the payment terminals remains a recurring need, it is interesting to study methods allowing the merchant to interact with the payment terminal, without contact with the latter (for example without interactions with the keypad).

One of the advanced solutions is that at the end of the transaction, the customer simply runs his hand, or his mobile phone, near the payment terminal, to specify his preference for printing a receipt. In particular, depending on the detected movement, for example up, down, left or right, the customer can select whether or not to print the payment receipt or even select an option to send it by email. However, this movement detection system requires the integration of an additional component, such as an optical sensor, in the payment terminal.

There is therefore a need for a technique for interactions between a user and a payment terminal, which does not have these various drawbacks. In particular, there is a need for such a technique which allows the user, customer or merchant, to make a function selection on the payment terminal without having to manipulate it, taking advantage in particular of the technical specificities of the near field communication used for contactless payment.

### 3. DISCLOSURE OF THE INVENTION

The invention meets this need by proposing a method for processing electromagnetic field modulations of a contactless payment terminal. This contactless payment terminal emits an electromagnetic field to establish a near field communication (NFC) with a payment device of a user. In particular, the method comprises the following steps, implemented within the payment terminal:
detection by the payment terminal of at least one modulation of the emitted electromagnetic field, said at least one modulation resulting from at least one touch of the payment device on the payment terminal,
determination of a modulation frequency N, N being an integer greater than or equal to 1, of the electromagnetic field emitted by the payment terminal, this frequency N corresponding to N touches of the payment device on the payment terminal,
a selection of at least one function on the payment terminal according to the modulation frequency N of the determined electromagnetic field.

Thus, the invention is based on an entirely new and inventive approach to the interaction between a payment device of a user and a so-called contactless payment terminal, using near field communication (NFC) technology. More particularly, the invention proposes to take advantage of the use of this NFC communication technology, already used during a conventional contactless payment step, to be able to select one or several functions available on the contactless payment terminal, that is to say without requiring direct physical interaction between the user, such as for example a customer or a merchant, and the payment terminal.

To this end, when purchasing a product or a service, a conventional electronic transaction step is implemented. In particular, the customer brings his payment device, such as for example his bank card or his mobile phone, close to the contactless payment terminal, then, after establishing an NFC communication, the payment device and the contactless payment terminal exchange transaction information necessary to initiate and complete the electronic transaction. This transaction information is for example, data for identifying and authenticating the customer's payment device, for identifying the payment terminal, of transaction amount, etc.

When the user, customer or merchant, needs to interact with the contactless EPT, for example to select a function such as printing the payment receipt, the method according to the invention makes it possible to limit physical contacts between the user and the EPT. To this end, in order to be able to select one or several functions on the EPT, the latter detects a modulation of the electromagnetic field that it emits related to the “touch”, or “tap”, of the user's payment device on the EPT.

By “touch” or “tap” it should be understood bringing the payment device close to the EPT to establish an NFC communication between the two peripherals, or at least a modulation of the electromagnetic field emitted by the EPT for the payment device. More particularly, during a step of selecting a function on the contactless EPT, during which there is no exchange of transaction information between the payment device and the EPT, the user is invited to use his payment device (contactless bank card or mobile phone) and “touch” the EPT. The EPT which emits an electromagnetic field is then able to detect a disturbance in the absorption profile of the electromagnetic field.

Thus, the detection of a modulation or a disturbance of the electromagnetic field emitted by the payment terminal makes it possible to select a function on the payment terminal. In other words, the user can make the selection of a function for using the payment terminal by modulating the electromagnetic field of the terminal with his payment device, without coming into direct contact with it, by a single “tap” of his payment device on the payment terminal. There is therefore no need to manipulate the EPT by entering its choice of function, for example using the keypad of the terminal. On the contrary, the selection is made without contact via a modulation of the electromagnetic field emitted by the terminal to establish a near-field communication and without the need to exchange transaction information as during the transaction step.

In particular, depending on the modulation frequency of the electromagnetic field emitted by the payment terminal, the user can select a function on the terminal, that is to say, to each modulation frequency of the electromagnetic field corresponds a function on the payment terminal. In other words, if the payment terminal determines a modulation frequency N of the electromagnetic field (N being an integer greater than or equal to 1), then it implements the function corresponding to this modulation frequency. Thus, in order to select a function on the payment terminal, the user will “touch” the payment terminal, or performs a “tap” with his payment device, and consequently modulate the electromagnetic field emitted by the terminal. Each time the user performs a “tap”, the electromagnetic field is modulated and thus, for N “tap”, a modulation frequency N of the electromagnetic field is determined. In one example, to select the function of printing the payment receipt, the user must perform two consecutive “tap” with his payment device on the payment terminal. The modulation frequency N=2 is then determined and the print function is selected and implemented.

According to a particular aspect of the invention, the method further comprises a determination of at least one parameter chosen from:
a modulation period of the electromagnetic field,
a modulation amplitude of the electromagnetic field,
a threshold of approach of the payment device to the payment terminal.

Advantageously, the determination of a period between the detected modulations of the electromagnetic field, of a modulation amplitude and/or an approach threshold makes it possible to filter out possible spurious interactions. In other words, the method according to the invention makes it possible to detect a voluntary gesture from the user and therefore to accurately select a function on the payment terminal.

According to another particular aspect of the invention, this selection of said at least one function on the payment terminal is implemented before and/or after a contactless electronic transaction step.

Advantageously, the user can select a function on the contactless payment terminal before and/or after the contactless electronic transaction step, according to a predetermined sequence of functions. In one example, before performing the conventional contactless electronic transaction step, the user is asked if he wishes to print his payment receipt or not. By a single “tap”, the user selects that he wishes for example to print his payment receipt, then performs in a conventional manner an electronic contactless transaction to make the purchase of a product or service. At the end of the transaction, the user is asked for example to make a donation to an association. The user can then select to make this donation in the same way as for selecting the function of printing the payment receipt, by a single “tap” of his payment device on the payment terminal. Thus, the user can select one or several functions on the payment terminal before and/or after the electronic transaction step without payment, by performing the number of “tap” required to select a function on the terminal.

According to one feature of the invention, said at least one function selected on the payment terminal is selected from:
a function of printing a payment receipt,
a function of transmitting a payment receipt by e-mail,
a function of transmitting a payment receipt by SMS or MMS,
a function of accepting the payment of a tip,
a function of accepting the payment of a donation,
a function of implementing at least one other contactless electronic transaction.

Thus, before and/or after the actual conventional electronic transaction step, the payment terminal displays on a screen a list of functions from which the user can select in order, for example, to print his payment receipt or send it by e-mail to an address recorded with the merchant. For each function, a modulation frequency N is associated. In other words, for each function, a number N of “tap” to be performed is associated and displayed. In one example, to select to print the payment receipt, the terminal screen displays that you have to perform a single “tap” corresponding to a “tap” on the payment terminal with the payment device (bank card or mobile phone), and to select to send it by e-mail, you have to perform a double “tap”, corresponding to two “taps”.

According to another feature of the invention, the method according to the invention comprises displaying on a screen of the payment terminal a message for selecting said at least one function, this message comprising the modulation frequency N, N being an integer greater than or equal to 1, of the electromagnetic field making it possible to select said at least one function.

Thus, the user (or customer) can select from several different functions, without having to physically interact with the payment terminal. The user can therefore very simply select, either to receive his payment receipt in physical form, that is to say he selects to print the payment receipt by the payment terminal, or to have this payment receipt sent by e-mail or by SMS or MMS type messaging. In another example, if the user wishes to make a donation to an association or to give a tip to the merchant (for example when it is a restaurateur), the method according to the invention allows him to select a function of implementing another transaction on the contactless payment terminal.

The invention also concerns a device for processing electromagnetic field modulations of a contactless payment terminal. This contactless payment terminal emits an electromagnetic field to establish a near field communication (NFC) with a payment device of a user. In particular, this device comprises:
a module for detecting by the payment terminal at least one modulation of the emitted electromagnetic field, said at least one modulation resulting from at least one touch of the payment device on the payment terminal,
a module for selecting a function on the payment terminal, this selection module also being capable of:
i. determining a modulation frequency N, N being an integer greater than or equal to 1, of the electromagnetic field emitted by the payment terminal, the frequency N corresponding to N touches of the payment device on the payment terminal,
ii. selecting at least one function on the payment terminal according to the modulation frequency N of the determined electromagnetic field.

The invention also concerns a payment terminal comprising a device for processing electromagnetic field modulations of a contactless payment terminal, as described above.

According to a preferred implementation, the various steps of the methods according to the present disclosure are implemented by one or several software or computer programs, comprising software instructions intended to be executed by a data processor of an execution terminal according to the present technique and being designed to control the execution of the various steps of the methods, implemented at the communication terminal, the electronic execution terminal and/or the remote server, as part of a distribution of the processing operations to be performed and determined by a script source code or a compiled code.

Consequently, the present technique is also aimed at programs that can be executed by a computer or by a data processor, these programs including instructions for controlling the execution of the steps of the methods as mentioned above.

A program may use any programming language, and be in the form of source code, object code, or intermediate code between source code and object code, such as in a partially compiled form, or in any other desirable form.

The present technique is also aimed at an information medium readable by a data processor, and including instructions of a program as mentioned above.

The information medium can be any entity or terminal capable of storing the program. For example, the medium may include a storage medium, such as a ROM, for example a CD ROM or a microelectronic circuit ROM, or else a magnetic recording medium, for example a mobile medium (memory card) or a hard drive or SSD.

On the other hand, the information medium can be a transmissible medium such as an electrical or optical signal, which can be conveyed via an electrical or optical cable, by radio or by other means. The program according to the present technique can in particular be downloaded to an Internet type network.

Alternatively, the information medium may be an integrated circuit in which the program is incorporated, the circuit being adapted to execute or to be used in the execution of the method in question.

According to an exemplary embodiment, the present technique is implemented by means of software and/or hardware components. From this perspective, the term “module” may correspond in this document to a software component, a hardware component or a set of hardware and software components.

A software component corresponds to one or several computer programs, one or several subprograms of a program, or more generally to any element of a program or a software capable of implementing a function or a set of functions, as described below for the relevant module. Such a software component is executed by a data processor of a physical entity (terminal, server, gateway, set-top-box, router, etc.) and is likely to access the hardware resources of this physical entity (memories, recording media, communication bus, electronic input/output cards, user interfaces, etc.).

In the same way, a hardware component corresponds to any element of a hardware assembly capable of implementing a function or a set of functions, as described below for the relevant module. It can be a hardware component that can be programmed or has an integrated processor for executing software, for example an integrated circuit, a smart card, a memory card, an electronic card for executing a firmware, etc.

Each component of the system described above naturally implements its own software modules.

The different embodiments mentioned above can be combined with each other for the implementation of the present technique.

The processing device, the aforementioned corresponding payment terminal and computer program have at least the same advantages as those conferred by the method for processing electromagnetic field modulations of a contactless payment terminal according to the different embodiments of the present invention.

### 4. LIST OF FIGURES

Other aims, features and advantages of the invention will appear more clearly upon reading the following description, given as a simple illustrative and not limiting example, in relation to the figures, among which:

FIG. 1A shows an example of an environment for implementing the invention according to a particular embodiment;

FIG. 1B shows an example of an environment for implementing the invention according to another particular embodiment;

FIG. 2 shows an architecture of a contactless electronic payment terminal according to an exemplary embodiment;

FIG. 3 graphically shows an example of an absorption profile of an electromagnetic field of a payment terminal according to an exemplary embodiment;

FIG. 4 schematically shows an example of the kinetics of a contactless payment phase and an opening phase according to an exemplary embodiment;

FIG. 5 graphically shows examples of the absorption profile of an electromagnetic field of a payment terminal during a selection of a function on an electronic payment terminal according to an exemplary embodiment;

FIG. 6 graphically shows an example of the absorption profile of an electromagnetic field of a payment terminal during a selection of a function on a payment terminal by double “tap” according to an exemplary embodiment;

FIG. 7 graphically shows an example of filtering of the absorption profile of an electromagnetic field of a payment terminal during a selection of a function on a payment terminal by double “tap” according to the exemplary embodiment of FIG. 6.

### 5. DETAILED DESCRIPTION OF THE INVENTION

An object of the present disclosure is to offer new possibilities for interaction of a user of a payment device (typically a bank card, or even a communication terminal used as a payment device) with a payment terminal having a near field communication interface (e.g. NFC). To achieve this objective, the general principle of use of the proposed technique is to make it possible to select a function on an electronic payment terminal (EPT) without direct physical interactions between the user and the EPT, in particular in order to be able to respond to health constraints of reducing such physical interactions. To do this, an interaction detection and processing method is implemented. In particular, the invention proposes, to allow this interaction, to take advantage of a near field communication technology (NFC) already implemented by the EPT as a part of contactless type payment transactions, also called contactless payment.

Thus, the invention is based on the modulation, by the user's payment device, of the electromagnetic field emitted by the EPT as a part of the implementation of NFC communications for contactless electronic transactions. To this end, the user will perform a “touch” or “tap” of the EPT using his payment device, such as for example his contactless bank card or mobile phone. This “tap” then modulates the electromagnetic field of the EPT which consequently determines, according to the described method, a function selected according to a modulation frequency of the electromagnetic field related to the number of performed “tap”.

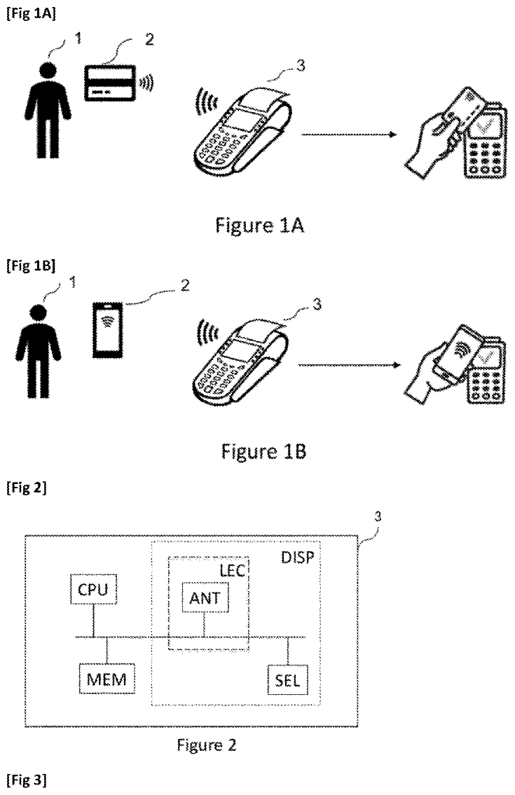

FIGS. 1A and 1B show examples of an environment for implementing the invention according to particular embodiments.

When purchasing a product, or a service, the user 1, or customer, is invited by the merchant to make a payment, for example using a payment means such as a bank card (FIG. 1A) or a mobile phone (FIG. 1B), for example his smartphone.

Currently, an electronic bank transaction, such as payment for a purchase, can be made via a contactless interface (not shown) of an electronic payment terminal 3. This type of contactless electronic transaction, also called contactless payment, is based on inductive coupling, also frequently called “near field communication” (or NFC). This NFC communication method is mainly based on the ISO (International Standard Organization) 14443 standard, and uses wireless technologies to allow an exchange of information between two peripherals located a short distance apart.

In practice, in this conventional and well-known contactless payment mode, the merchant enters the amount of the transaction on his EPT 3 which makes it possible to make a payment by means of a contactless interface (not shown) which is connected and driven by the EPT 3. The EPT 3 also comprises a user interface, also called HMI (for Human Machine Interface), comprising for example a screen intended to display messages to the user and a numeric keypad on which the user can compose a code for example.

The user 1 is then invited, via a message displayed on the screen, to show his payment means, also called payment device 2 below, such as for example his contactless bank card (FIG. 1A), or his smartphone (FIG. 1B), on this contactless interface within a determined period (for example 1 minute), in order to proceed with the payment of his purchase.

This transaction step involves a secure exchange of transaction information, such as for example data for identifying and authenticating the payment device 2 and/or the user 1. To this end, the user 1 physically positions his payment device 2 in front of the contactless interface of the EPT 3, at a maximum distance of 3 or 4 centimeters to pay for his purchase. Concretely, it is therefore appropriate for the user 1 to “touch” the contactless interface of the EPT 3. This physical contact between the payment device 2 and the EPT 3 is commonly called “tap”. The user 1 then holds his payment device 2 facing the contactless interface of the EPT 3, until a signal (beep and/or distinctive light) indicates the end of the transaction. For the merchant, this signal characterizes the validation of the transaction and the printing of a sales check and possibly a payment receipt (for example bank card receipt) for the customer 1.

In relation to FIG. 2, an architecture of a contactless electronic payment terminal 3 according to an exemplary embodiment is shown.

The EPT 3 is a contactless type EPT, that is to say it is capable of establishing an NFC communication with a payment device 2 of the user 1, such as for example his contactless bank card, to make a transaction, or contactless payment.

The contactless EPT 3 conventionally comprises:
a processing unit or “CPU”, intended to load instructions into memory, to execute them, to perform operations,
a set of memories MEM, including a volatile memory or “RAM” (for “Random Access Memory”) used to execute code instructions, store variables, etc., and a non-volatile memory, of the “ROM” or “EEPROM” type intended to contain persistent information.

The contactless EPT 3 also comprises a device for processing electromagnetic field modulations of the contactless EPT 3, or a processing device DISP. In particular, the processing device DISP comprises a contactless reader LEC, conventionally integrated into a contactless type EPT. The contactless reader LEC of the EPT 3 is an active system that emits an electromagnetic field by means of an integrated antenna ANT and sends data by modulation of the amplitude of the emitted electromagnetic field. Indeed, the contactless EPT 3 emits an electromagnetic field via the integrated antenna ANT to be able to establish at any time an NFC communication with the payment device 2 of the user 1.

Thus, a conventional contactless payment phase consists of the exchange of electromagnetic waves between the payment device 2 of the user 1 (for example a bank card or a smartphone) and the contactless EPT 3 of the merchant. In particular, during this contactless payment phase, the electromagnetic field of the contactless EPT 3 is more or less absorbed, depending on the presence in the field of the payment device 2, such as for example the bank card of FIG. 1A.

More particularly, the payment device 2 conventionally has a chip containing the information necessary for the transaction and a miniature antenna which sends the data by short-distance radio waves to the contactless EPT 3, itself equipped with the integrated antenna ANT. The chip of the payment device 2 sends data to the contactless reader LEC of the contactless EPT 3 by load modulation, that is to say by short-circuiting its antenna circuit by means of a switch driven by a load modulation signal. Antenna short circuits cause a disturbance of the electromagnetic field which is reflected in the contactless reader LEC. The latter can thus extract the load modulation signal by performing a filtering of the signal and deduce therefrom the data sent by the payment device 2. The electromagnetic field can be modified in various ways recognizable by the contactless reader LEC and converted into binary digits 1 and 0. Waves can be increased or decreased (amplitude modulation) or time shifted (phase shift keying). It is also possible to vary the frequency (frequency shift keying) or else to ensure that the data is contained in the duration of the pulses (pulse width modulation).

The merchant's EPT is then able to access the data stored on the customer's payment device, record a transaction, and communicate with a remote authentication server.

The processing device DISP of the contactless EPT 3 further comprises a selection module SEL of a function on the contactless EPT 3. By “function” it should be understood a particular action which is performed by the contactless EPT 3 following a user's command. This function can be for example:
a function of printing a payment receipt (for example a bank card receipt or bill),
a function of transmitting a payment receipt by e-mail,
a function of transmitting a payment receipt by SMS or MMS,
a function of accepting the payment of a tip,
a function of accepting the payment of a donation (typically a donation allowing the total amount of purchases to be rounded up to a higher monetary unit),
a function of rating the service provided by the merchant,
a function of implementing at least one other contactless electronic transaction.

Hereafter, the payment receipt transmission function is mainly used to describe the interaction examples. It is well understood that these examples can be implemented for functions other than that of transmitting such payment receipts.

In other words, the user 1 can very simply select, either to receive his payment receipt in physical form, that is to say he selects to print the payment receipt by the payment terminal, or to have this payment receipt sent by e-mail or by SMS or MMS type messaging, when an e-mail address or a telephone number are known to the merchant (for example recorded in a database of the merchant). In another example, if the user 1 wants to make a donation to an association or else to give a tip to the merchant (for example when it is a restaurateur), he then selects either a function of implementing another transaction on the contactless payment terminal.

To this end, the contactless EPT 3 displays on its screen the different functions that it can select in association with a number N (N being an integer greater than or equal to 1) of “tap” that must be performed to select a function in particular. The contactless reader LEC of the EPT 3 then detects the modulations of the electromagnetic field emitted by the antenna ANT resulting from the presence in the field of the payment device 2 when the user 1 performs a “touch” or “tap” of his payment device 2 on the EPT 3. The selection module SEL then determines a modulation frequency N (N being an integer greater than or equal to 1), of the electromagnetic field emitted by the contactless EPT 3. This frequency N corresponding to the number N of “tap” that the user performs with his payment device 2 on the EPT. Thus, according to this modulation frequency N of the electromagnetic field, the module SEL makes it possible to select a corresponding function. In one example, the user wishes his payment receipt to be sent by e-mail to an e-mail address recorded in the merchant's database. To this end, he is invited, at the end of the contactless payment, to perform a double “tap” with his bank card on the contactless EPT 3. The contactless reader LEC therefore detects a modulation of the emitted electromagnetic field and the selection module SEL determines that the modulation frequency is N=2 and that consequently it is the function of transmitting the receipt by e-mail that is selected by the user 1.

Thus, the user can select different functions on the contactless EPT 3 in a dematerialized manner, that is to say without direct physical contact, by “touching” it with his payment device 2. Indeed, it is the detection of a modulation or disturbance of the electromagnetic field emitted by the EPT by the contactless reader LEC that makes it possible to select via the selection module SEL a function on the EPT. The user therefore no longer needs to manipulate the contactless EPT 3 by entering his choice of function, for example using the keypad. Indeed, the selection is made without direct contact between the EPT 3 and the user 1 thanks to a modulation of the electromagnetic field of the EPT 3 and without the need to exchange transaction information as during the contactless payment phase.

According to an exemplary embodiment, this step of selecting a function is carried out at the end of the conventional contactless payment phase. The user is then invited, via the display of functions on the EPT 3 screen, to select a function of printing or sending his payment receipt by e-mail. To select the function of printing the payment receipt, the user 1 performs a single “tap” (N=1) with his payment device 2, for example his bank card. To select a function of transmitting the payment receipt by e-mail, the user 1 performs a double “tap” (N=2) with his bank card.

In another exemplary embodiment, this selection is made before the conventional contactless payment phase is carried out.

In another exemplary embodiment, the user 1 chooses before the conventional contactless payment phase a function, such as printing his payment receipt by performing a single “tap” with his bank card, then conventionally makes a contactless payment, before selecting another function displayed on the screen at the end of the payment such as for example giving a tip to the merchant or making a donation to an association.

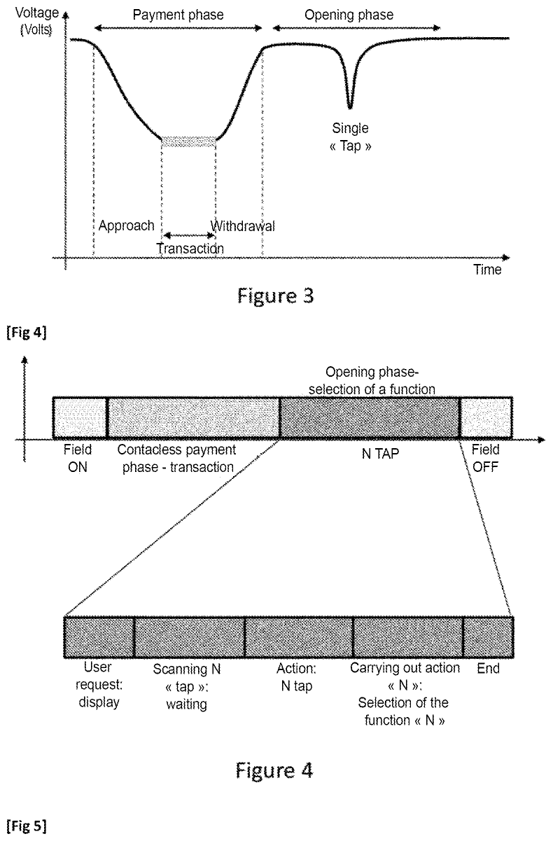

An example of the absorption profile of the electromagnetic field emitted by the contactless EPT 3 used for the implementation of the present technique is now shown in FIG. 3. The contactless reader LEC of the EPT 3 being sensitive to the absorption of the electromagnetic field, it is therefore able to perceive these modulations by a variation of the voltage at the integrated antenna ANT.

Thus, during a conventional contactless payment phase, there are three steps:
an approach step, where the absorption of the electromagnetic field increases and therefore the voltage (in volts) decreases,
a transaction step with exchange of digital data (or transaction information),
a withdrawal step, where the absorption of the electromagnetic field decreases and therefore the voltage (in volts) increases.

In the example related to FIG. 3, the user 1 is invited to select a function on the contactless EPT 3 at the end of the contactless payment phase. It should be noted that this selection step can also be carried out before the contactless payment phase, or, in another example, before and after payment.

FIG. 4 schematically shows an example of the kinetics of a contactless payment phase and an opening phase for the selection of a function on the contactless EPT 3 according to an exemplary embodiment.

In this example, the N “tap” occurs after an electronic contactless payment transaction.

During an opening phase, the contactless reader LEC scans for possible modulations of the electromagnetic field related to one or several “tap” of the user with his payment device 2. When the user “taps” with his payment device 2, the contactless reader LEC detects the disturbance of the electromagnetic field. This modulation of the electromagnetic field is characterized by a brief variation of the field during which the absorption increases briefly before decreasing, as shown in relation to FIG. 3. The selection module SEL then determines the modulation frequency N of the field, then selects the corresponding function called by the user. During this selection step, there is no digital dialogue (exchange of data, for example bank data) between the contactless EPT 3 and the payment device 2, such as for example the bank card. The contactless reader LEC of the EPT 3 determines if there is a modulation of the electromagnetic field and according to this modulation, via the selection module SEL, selects the corresponding function on the payment terminal. Indeed, depending on the profile of this absorption (value and duration) it is possible to detect a movement, or number of specific “tap”, activating a function at the contactless EPT 3.

In one example, the merchant initiates contactless payment in a conventional and well-known manner. The user 1 makes the transaction by placing, for example, his bank card in the field of the contactless reader LEC of the EPT 3. Once the transaction is completed, a message is displayed on the screen of the contactless EPT 3 asking the user 1 if he wishes for example to print a payment receipt with a double “tap” for validation. The user 1 then uses his contactless bank card to carry out this action that prints the payment receipt.

It is entirely possible to initiate this action before the transaction, or to perform another action (transmission of the payment receipt by e-mail, sales check by SMS, etc.) or to use the depth of the N “tap”; in this case a single “tap” will carry out action 1, a double “tap” will carry out action 2 etc.

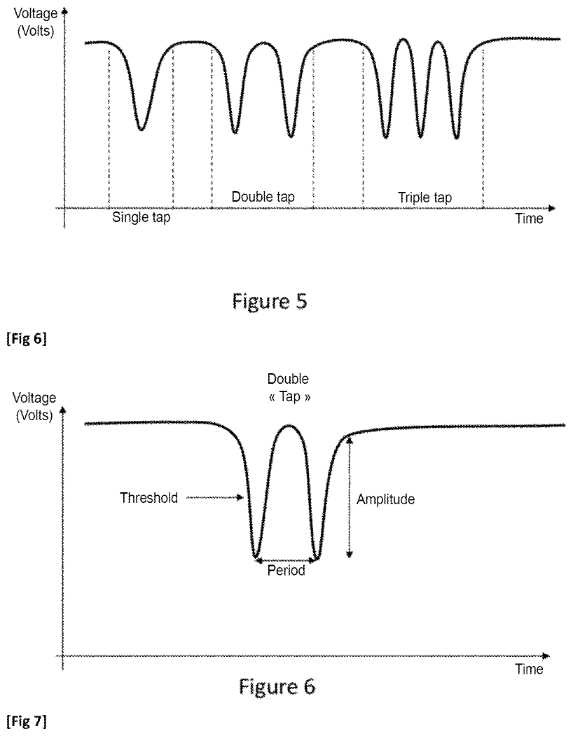

Examples of the absorption profile of the electromagnetic field emitted by the contactless EPT 3 during the implementation of a selection of a function according to an exemplary embodiment are shown in relation to FIG. 5.

In one example, when the user 1 “touches” or “taps” the contactless EPT 3 only once with his payment device 2, he then performs a single “tap” characterized by an absorption peak of the electromagnetic field, and a decrease in voltage. In this case, the selection module SEL determines that the frequency N is equal to 1 and that the function called by the user is that corresponding to a single “tap”, for example printing of the payment receipt by the contactless EPT 3.

In another example, when the user 1 “touches” or “taps” twice in a row the contactless EPT 3 with his payment device 2, he then performs a double “tap” characterized by the appearance of two absorption peaks of the electromagnetic field, and a decrease in voltage. In this case, the selection module SEL determines that the modulation frequency N is equal to two and that the function called by the user is that corresponding to a double “tap”, for example sending the payment receipt by e-mail.

In another example, when the user 1 “touches” or “taps” three times in a row the contactless EPT 3 with his payment device 2, he then performs a triple “tap” characterized by the appearance of three absorption peaks of the electromagnetic field, and a decrease in voltage. In this case, the selection module SEL determines that the modulation frequency N is equal to three and that the function called by the user is that corresponding to a triple “tap”, for example sending the payment receipt by SMS or MMS type messaging.

Thus for an integer number N greater than or equal to 1 of “tap”, there are therefore N modulations of the electromagnetic field characterized by a number N of absorption peaks. The selection module SEL then determines the modulation frequency N which then makes it possible to select the corresponding function N. In other words, the user 1 must perform N “tap” and thus, depending on the modulation frequency N of the electromagnetic field emitted by the contactless EPT 3, the user can select a corresponding function N without direct interaction between the user 1 and the EPT 3.

An example of the absorption profile of an electromagnetic field of the contactless EPT 3 during an implementation of a selection of a function by double “tap” according to an exemplary embodiment is now shown in relation to FIG. 6.

In this example, the user approaches his payment device 2 twice, such as his contactless bank card, at the contactless interface of the EPT 3, to perform a double “tap”, in order for example, to select a function of transmitting the payment receipt by e-mail.

The contactless reader LEC of the EPT 3 detects a modulation of the electromagnetic field emitted by the antenna ANT of the EPT 3 characterized by two absorption peaks of the field.

The selection module SEL then determines an approach frequency N=2 which makes it possible to deduce the called function. This determined approach frequency is an entry data for the filtering of spurious absorptions (reduction of the spurious background by filtering) which could occur (even if they remain very low, the operating frequency (13.56 MHz) of the interface being away from water absorption).

The selection module SEL also determines the following parameters:
a modulation period of the electromagnetic field,
a modulation amplitude of the electromagnetic field. The amplitude of these movements making it possible to trigger the capture as well as the filtering of spurious absorptions,
a threshold of approach of the payment device to said contactless payment terminal.

Thus, it is possible to detect a voluntary gesture from the user for the selection of a function on the contactless EPT 3.

In particular, in an exemplary embodiment, the filtering of noise and spurious transient events (i.e. spurious absorption filtering) is carried out either via the use of digital type filtering, or via the use of analog type filtering according to the topology of the signal. In other words, in order to remove signals with a frequency higher than the form of the desired signal, a filter is set up. This filtering is:
either of the digital type with a low level of latency (typically an infinite impulse response filter, or a filter making averages with a small amount of data);
or of the analog type based on passive components if the detection of at least one modulation of the emitted electromagnetic field is carried out externally to the modulation processing device according to the invention.

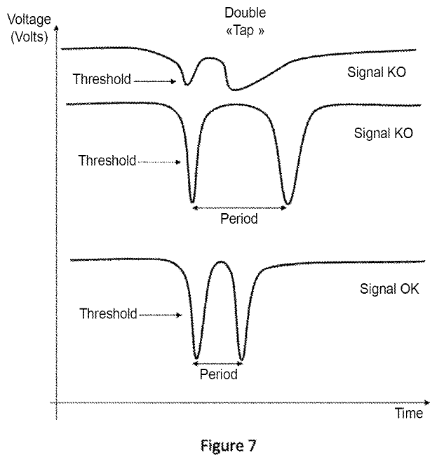

FIG. 7 illustrates an example of filtering of the absorption profile of an electromagnetic field of the contactless EPT 3 during an implementation of a selection of a function by double “tap” according to the example of FIG. 6.

In this example, to obtain the absorption profile related to FIG. 6, the selection module SEL determines in addition to the approach frequency, the parameters of modulation period of the electromagnetic field, of modulation amplitude of the electromagnetic field and/or of threshold of approach of the payment device to the contactless payment terminal. The use of additional parameters to determine the modulation frequency makes it possible to set up a noise filtering system in addition to the filtering described above. Thus, if any of these parameters, or a combination of these parameters is not respected, then the signal is rejected (“signal KO”) as being noise or a spurious event: it is the case of the first two signals of FIG. 7, in which either the amplitude or the period do not respect the prescribed parameter setting. On the contrary, if all the parameters (amplitude, approach threshold and/or period) are respected, then the signal is accepted as a voluntary gesture from the user (“signal OK”).

The determination of one or several of these parameters in combination with the determination of the modulation frequency makes it possible to more accurately detect a voluntary gesture from the user and thus avoid bad manipulations.

1. A method for processing electromagnetic field modulations of a contactless payment terminal, said contactless payment terminal emitting an electromagnetic field for establishing a near field communication (NFC) with a payment device of a user, said method comprising the following steps, implemented within the payment terminal:
detection by said payment terminal of at least one modulation of said emitted electromagnetic field, said at least one modulation resulting from at least one touch of said payment device on said payment terminal,
determination of a modulation frequency N, N being an integer greater than or equal to 1, of said electromagnetic field emitted by said payment terminal, said frequency N corresponding to N touches of said payment device on said payment terminal, of a modulation amplitude of said electromagnetic field, and of a threshold of approach of said payment device to said payment terminal,
a selection of at least one function on said payment terminal 3)-according to said modulation frequency N of said determined electromagnetic field.

2. The processing method according to claim 1, wherein it further comprises a determination of a modulation period of said electromagnetic field.

3. The processing method according to claim 1, wherein said selection of said at least one function on said payment terminal is implemented before and/or after a contactless electronic transaction step.

4. The processing method according to claim 1, wherein said at least one function selected on said payment terminal is selected from:
a function of printing a payment receipt,
a function of transmitting a payment receipt by e-mail,
a function of transmitting a payment receipt by SMS or MMS,
a function of accepting the payment of a tip,
a function of accepting the payment of a donation,
a function of implementing at least one other contactless electronic transaction.

5. The processing method according to claim 1, wherein it comprises displaying on a screen of said payment terminal a message for selecting said at least one function, said message comprising said modulation frequency N, N being an integer greater than or equal to 1, of said electromagnetic field making it possible to select said at least one function.

6. A device for processing electromagnetic field modulations of a contactless payment terminal, said contactless payment terminal emitting an electromagnetic field for establishing a near field communication (NFC) with a device payment of a user, said device comprising:
a module for detecting by said payment terminal at least one modulation of said emitted electromagnetic field, said at least one modulation resulting from at least one touch of said payment device on said payment terminal,
a module for selecting a function on said payment terminal, said selection module also being capable of:
i. determining a modulation frequency N, N being an integer greater than or equal to 1, of said electromagnetic field emitted by said payment terminal, said frequency N corresponding to N touches of said payment device on said payment terminal, a modulation amplitude of said electromagnetic field, and a threshold of approach of said payment device to said payment terminal,
ii. selecting at least one function on said payment terminal according to said modulation frequency N of said determined electromagnetic field.

7. A payment terminal, wherein it comprises a device for processing electromagnetic field modulations of a contactless payment terminal according to claim 6.

8. A computer program product comprising program code instructions for implementing a method for processing electromagnetic field modulations of a contactless payment terminal according to claim 1.
